(19) United States
(12) Patent Application Publication
(10) Pub. No.: US 2004/0220435 A1
(43) Pub. Date: Nov. 4, 2004

(54) Processing of organic material

(76) Inventor: Thomas John Stubbing, Pukekohe (NZ)

Correspondence Address: JOEL D. SKINNER, JR., SKINNER AND ASSOCIATES, 212 COMMERCIAL ST., HUDSON, WI, 54016, US

(21) Appl. No.: 10/486,625

(22) PCT Filed: Mar. 28, 2002
(86) PCT No.: PCT/GB02/01497

(30) Foreign Application Priority Data
Aug. 11, 2001 (GB) 0119616.1

(51) Int. Cl. C10G 1/00; C10B 21/20

(52) U.S. Cl. 585/242; 202/96; 202/99

(57) ABSTRACT

A method for processing organic material including heating the organic material to a temperature exceeding 100° C. in an atmosphere including at least one of superheated steam, a hot inert gas, hot air and hot process gases, and subsequently cooling the heated organic material in an atmosphere including at least one of superheated steam and an inert gas. Also described are processing apparatus for use in performing the method.

The invention relates to methods and apparatus for the processing of organic material in superheated steam and/or other gases in order advantageously to alter its physical properties and/or its chemical composition while usefully recovering or combusting components emitted from it as gases and then to cool its solid residues in an inert gas to prevent said solid residues' spontaneous ignition on re-entering ambient air. The organic material may be moist organic material, in which case a first operation of drying the material, conveniently in superheaded steam, may be included. The invention is applicable to continuous processing, batch processing and continuous, sequenced batch processing of materials.

The expression “organic material” includes green and post-consumer wood and other organic material such as forestry and agricultural wastes and any other mainly or partly organic material such as paper and food industry sludges and municipal and commercial waste streams containing, for example, food, paper and plastic residues and used tyres which may advantageously be processed according to the invention. It will be appreciated that in many cases the organic material will have a significant moisture content.

It is known continuously to dry moist materials in superheated steam. For example, British Patent Specification No. 2281383 describes an apparatus for continuous drying of moist materials in superheated steam comprising a drying enclosure, open-ended inlet and outlet ducts communicating with the enclosure and conveyors for conveying the material to be dried along the inlet duct, through the enclosure and along the outlet duct. Superheated steam is generated in the enclosure from the moisture in the material being dried by circulating the initial gas within the enclosure between a heat source and the material, and/or by the injection into the enclosure of superheated steam from an external source. The inlet duct and outlet duct both extend downwardly from the enclosure and a vent duct from the enclosure has an outlet normally at a level midway along the two ducts. In use, superheated steam tending to pass downwardly along the ducts meets external air tending to pass upwardly along the ducts and forms within each duct a steam/air temperature and density differential stratification layer. These stratification layers act as barriers to the escape of steam from the enclosure and/or entry of air into the enclosure while at the same time permitting the free conveyance of material along the ducts and into and out of the enclosure.

Specification No. 2281383 thus discloses a continuous drying process in which materials to be dried pass into and/or out of the drying enclosure through a non-mechanical barrier which allows the free passage of the materials without any significant restraint, while at the same time providing effectively substantially gas-tight seals to prevent the escape of superheated steam from the drying enclosure or the entry of air into the enclosure. Steam escaping through the vent duct may be condensed to recover its thermal energy.

According to the present invention there is provided a method of processing organic material comprising heating the organic material to a temperature exceeding 100° C. in an atmosphere comprising at least one of superheated steam, a hot inert gas, hot air and hot process gases, and subsequently cooling the heated organic material in an atmosphere comprising at least one of superheated steam and an inert gas. The invention also relates to an apparatus designed to permit the use of the method in a relatively simple and convenient form.

The present invention thus sets out to provide methods and apparatus for continuous, batch, or continuous sequenced batch processing of material, for example moist organic material, in superheated steam and other gases whereby the material to be processed either passes into and/or out of drying, processing and cooling enclosures respectively through non-mechanical barriers which allow the free passage of the material without any significant restraint, or through mechanical barriers in the form of doors able to be closed in airtight manner, said non-mechanical or mechanical barriers providing effectively substantially gas-tight seals to prevent the movement of superheated steam, hot process gases or inert cooling gas from or between the drying, processing or cooling enclosures, respectively, or the entry of air into said drying, processing and/or cooling enclosures, in order first to dry the moist material in superheated steam, then to process the dried material in hot process gases at a temperature higher than that required to dry it to alter its physical properties and/or its chemical composition while recovering or combusting components emitted from it as gases, and finally to cool the processed material's solid residues in an inert gas, preferably but not exclusively superheated steam, to a temperature typically slightly above 100° C. but in any event below that at which said residues could ignite spontaneously on re-entering ambient air, or whereby said material to be processed is placed as a batch in, and said batch is then dried, processed and cooled in at least one substantially airtight drying, processing and cooling enclosure.

One form of said apparatus comprises a drying enclosure, at least one processing enclosure and a cooling enclosure, conveying means passing into and through said drying, processing and cooling enclosures and out of said cooling enclosure through ducts either communicating with or linking said enclosures, said enclosures and said ducts being thermally insulated, whereby, except where mentioned hereafter, said enclosures and said ducts, and their junctions with said enclosures, are all airtight.

During an initial warm-up period the drying enclosure is heated by recirculating the ambient air atmosphere initially contained in said drying enclosure over a heat source by reciriculation fan means while moist material begins to be transported by said conveying means into and through the drying enclosure. The recirculation ambient air atmosphere is displaced and replaced by recirculating superheated steam generated from the moisture in the material by the known method described in Specification No. 2281383, whereby said recirculating superheated steam then completes the drying of the material and the additional steam generated from the moisture in said material is vented, preferably but not exclusively into condensing means, as described in Specification No. 2281383, before said material is transported out of the drying enclosure said into at least one processing enclosure.

Before the dried material begins to be transported from the drying enclosure into the said at least one processing enclosure by the said conveying means, warm-up of the at least one processing enclosure is initiated by reccirculating the ambient air atmosphere initially contained in said at least one processing enclosure over a heat source by means of a recirculation fan and, once the temperature of the air in said at least one processing enclosure exceeds 100° C., said air may be displaced and replaced either by an externally provided inert gas atmosphere or, by temporarily venting some or all of the steam being generated in the drying enclosure via a dampered duct into said at least one processing enclosure instead of venting it into the said condensing or cooling means, by a superheated steam atmosphere, whereby said ambient air atmosphere, said externally provided inert gas atmosphere or said superheated steam atmosphere then contained in the at least one processing enclosure is heated to a temperature above that at which drying in superheated steam is proceeding in the said drying enclosure by recirculating it over said heat source and through said at least one processing enclosure by means of said recirculation fan.

As the dried material begins to be transported through said at least one processing enclosure and processed at said temperature above that at which drying in superheated steam is proceeding in said drying enclosure, hot process gases generated from said dried material displace and replace the air, inert gas or superheated steam atmosphere in said at least one processing enclosure, following which heating and processing of the said dried material proceeds by recirculating said hot process gases over said heat source and through said dried material in said at least one processing enclosure by said recirculation fan means, whereby said temperature above that at which drying in superheated steam is proceeding in the drying enclosure is maintained and the additional hot process gases generated from said dried material being transported through and processed in said at least one processing enclosure are vented either into condensing or cooling means or, when said additional hot process gases are combustible, into combustion means, while any combustible incondensible gases which emerge from said condensing or cooling means, if employed, are ducted into said combustion means, and the said heat source may be heated by the combustion gases generated by the combustion of said additional hot process gases and of said combustible incondensible gases, if any, in said combustion means.

Before the hot solid residues remaining after hot process gases have been generated from said dried material begin to be transported from said at least one processing enclosure into said cooling enclosure by said conveying means, replacement of the ambient air atmosphere initially contained in the cooling enclosure may be carried out, either by recirculating the ambient air atmosphere initially contained in the cooling enclosure over said heat source by means of a recirculation fan in order to heat it or, for example, by heating said ambient air atmosphere by arranging for a portion of the flue gases emerging from the said heat source to enter the cooling enclosure whereby, once the temperature of the air or air with a portion of flue gas atmosphere in said cooling enclosure exceeds 100° C., said ambient air or air with a portion of flue gas atmosphere may be displaced and replaced by a superheated steam atmosphere by temporarily venting some or all of the additional steam being generated in the drying enclosure via dampered duct means into said cooling enclosure instead of venting it into said condensing or cooling means or, alternately, the said ambient air atmosphere initially contained in the cooling enclosure may be displaced and replaced by an externally provided inert gas atmosphere.

When the atmosphere in the cooling enclosure is ambient air, as the said hot solid residues are transported through the cooling enclosure's air atmosphere, limited combustion of a small portion of said solid residues occurs and the air atmosphere is displaced and replaced by the hot and virtually oxygen-free combustion gas produced. Thereafter said hot and virtually oxygen-free combustion gas is recirculated by recirculation fan means through said cooling enclosure and through condensing or cooling means in which any hot process gases generated from the hot solid residues are condensed and the said hot and virtually oxygen-free combustion gas cooled, whereby, on its return to said cooling enclosure, the thus cooled combustion gas in turn cools said hot solid residues before they are transported out of said cooling enclosure into ambient air by said conveying means.

When the said atmosphere in said cooling enclosure is superheated steam, as the said hot solid residues are transported through said cooling enclosure's superheated steam atmosphere, said superheated steam is recirculated by fan means through said cooling enclosure into which atomised cooling water is injected by water atomising means, preferably but not exclusively into the eye of said fan means, at a rate sufficient to cool said superheated steam to slightly above 100° C. whereby the additional steam generated in the said cooling enclosure from the atomised water and any hot process gases generated from said hot solid residues are condensed in said condensing or cooling means while the thus cooled recirculating superheated steam in turn cools said hot solid residues before they are transported out of said cooling enclosure into ambient air by said conveying means.

When the said atmosphere in said cooling enclosure is an inert gas other than superheated steam, as the said hot solid residues are transported through said cooling enclosure's inert gas atmosphere, said inert gas is recirculated by fan means through said cooling enclosure and through said condensing or cooling means in which condensable components in any further hot process gases generated from said solid residues are condensed and the inert gas and any incondensable components in any said further hot process gases cooled to slightly above 100° C., whereby on their return to said cooling enclosure the thus cooled inert gas and any incondensable components in any said further hot process gases in turn cool said hot solid residues before they are transported out of said cooling enclosure into ambient air by said conveying means.

After completion of said initial warm-up period, said conveying means continue to transport the moist material out of ambient air, upwards through a steam/air stratification layer seal and into and through the superheated steam atmosphere in said drying enclosure, while said conveying means continue to transport the dried material out of the superheated steam atmosphere in said drying enclosure, downwards through a steam/air stratification layer seal and through ambient air before transporting said dried material upwards through a hot process gases/air stratification layer seal and into and through the hot process gases atmosphere in said at least one processing enclosure, while said conveying means continue to transport the processed material's solid residues out of the hot process gas atmosphere in said at least one processing enclosure, downwards through a hot process gases/air stratification layer seal and through ambient air before transporting said solid residues upwards through either a virtually oxygen-free combustion gas/air, superheated steam/air or other inert gas/air stratification layer seal and into and through a slightly above 100° C. combustion gas, superheated steam or other inert gas atmosphere in said cooling enclosure, while further conveying means transport the cooled residues out of the slightly above 100° C. combustion gas, superheated steam or other inert gas atmosphere in the cooling enclosure, downwards through a combustion gas, superheated steam or other inert gas/air stratification layer seal and into ambient air, whereby the said steam/air, hot process gases/air and combustion gas, steam or other inert gas/air stratification layer seals, which prevent the escape of superheated steam, other hot process gases, combustion gas, superheated steam and/or other inert gas respectively from the drying, processing and cooling enclosures respectively or the entry of air into said enclosures, are created and maintained naturally due to the densities of the above 100° C. steam, or process gases, or combustion gas, superheated steam or other inert gas atmospheres respectively above the said stratification layer seals being significantly less than that of ambient air, and the required above 100° C. drying and processing temperatures of said superheated steam in said drying enclosure and of said hot process gases in said processing enclosure are maintained by continuing separately to recirculate said superheated steam and said hot process gases over said at least one heat source by said enclosures' respective recirculation fan means, while the required slightly above 100° C. temperature of the said combustion gas, superheated steam or other inert gas in said cooling enclosure is maintained by heat transfer from the said hot solid residues being transported into and through said cooling enclosure, and the denser of said superheated steam in said drying enclosure, said hot process gases in said processing enclosure and said combustion gas, superheated steam or other inert gas in said cooling enclosure, all having differing densities below that of ambient air, are prevented by said steam/air, hot process gas/air and combustion gas, steam or other inert gas/air stratification layer seals from passing through said ducts linking said enclosures into an adjoining drying, processing or cooling enclosure.

At the commencement of the initial warm-up period the heating medium employed in said at least one heat source is combustion gases produced in said combustion means by burning an externally supplied fuel, but during or after said initial warm-up period the use of such externally supplied fuel may be reduced or eliminated as and when the thermal energy released by combusting the hot process gases vented directly to the said combustion means from said at least one processing enclosure and/or the incondensible gases emerging from any or all of said at least one condensing or cooling means becomes sufficient or more than sufficient to reduce or eliminate the use of such externally supplied fuel, whereby if more than sufficient thermal energy is released by combusting the gases vented directly to the said combustion means from said at least one processing enclosure and/or the incondensible gases emerging from any or all of said at least one condensing or cooling means than is required by said at least one heat source then most of any excess combustion gases may be employed to heat additional apparatus, preferably but not exclusively apparatus similar to that hereinafter described.

By way of example, if the material being dried and processed is wood and the cooled solid residues produced are charcoal, the thermal energy released by combusting the gases vented directly to said combustion means from said at least one processing enclosure and/or the incondensible gases emerging from any of the said at least one condensing or cooling means is more than sufficient to eliminate the use of said externally supplied fuel, whereby the excess thermal energy may be capable of drying and, if required, torrefying approximately twice as much wood as is processed to become charcoal in further drying, processing and cooling apparatus similar to that hereinafter described, or of being used to generate at least sufficient electrical energy to provide a portion of, all or more than the electrical energy requirement of any said apparatus according to the invention.

An alternate form of apparatus according to the invention comprises at least one drying, processing and cooling enclosure, each said drying, processing and cooling enclosure having a recirculation path within which an indirect heater, a recirculation fan, at least one container and an atomised water injection nozzle are located, whereby, in use, said at least one container is loaded with moist material and inserted into said drying, processing and cooling enclosure through an access door which is then closed in airtight manner. Said moist material is then dried and processed and its solid residues cooled by first recirculating indirectly heated gases through said moist material in order to dry it, then recirculating gases indirectly heated to a higher temperature through the thus dried material in order advantageously to alter its physical properties and/or its chemical composition while recovering or usefully combusting components emitted from it as gases and then recirculating cooling gases through the resulting solid residues in order to cool them, all generally as heretofore described except that, instead of said material being transported by conveying means first into and out of a drying enclosure, then into and out of a processing enclosure and then, as solid residues, into and out of a cooling enclosure, the drying, processing and cooling phases take place within said drying, processing and cooling enclosure from which, when the cooling phase is complete and said access door is opened, said at least one container and said solid residues contained in said at least one container are removed from said drying, processing and cooling enclosure and replaced by a further at least one container loaded with moist material inserted into said drying, processing and cooling enclosure through said access door which is again closed in airtight manner, enabling the next drying phase to commence and, when more than one drying, processing and cooling enclosure is provided, the drying phases in each drying, processing and cooling enclosure preferably commence in sequence.

A vent leads excess gases generated during the drying, cooling and processing phases respectively out of each said at least one drying, processing and cooling enclosure to atmosphere, either via a duct leading to atmosphere, or via a duct leading into and through an optional condenser, preferably but not exclusively common to all of said at least one drying, processing and cooling enclosures when more than one such enclosure is provided, or via a duct leading into a combustor, also preferably but not exclusively common to all of said at least one drying, processing and cooling enclosures when more than one such enclosure is provided, and any incondensible gases passing through said optional condenser may be ducted into said combustor, whereby, in use, atmospheric pressure is effectively maintained in each said drying, processing and cooling enclosure and valve or damper means direct said excess gases vented from each said drying, processing and cooling enclosure via a duct either directly to atmosphere, or indirectly to atmosphere through said optional condenser, or into said combustor.

By way of example, when the combined duration of said drying and cooling phases is less than three times as long as the duration of the generation of excess process gases from said dried material during said processing phase and four of said drying, processing and cooling enclosures are provided and when said excess gases are combustible, by sequentially starting the drying, processing and cooling phases respectively in each of said four enclosures when less than two thirds of the combined duration of the drying and cooling phases taking place in the previously started enclosures has elapsed, the durations of the generation of excess process gases from said dried material during the processing phases taking place in at least two of said enclosures overlap. This ensures that said excess process gases are continuously vented into a preferably but not exclusively common combustor in which said excess process gases are continuously and cleanly combusted and from which the continuously produced combustion gases are ducted through a duct, either through at least two of said indirect heaters, one such indirect heater being located in each of said enclosures, to provide at least some of the thermal energy required by the drying and processing phases taking place sequentially in at least two of said enclosures or, if not so required, to atmosphere, while, if toxic emissions are not present in the excess gases generated and vented during the drying and cooling phases, said excess gases may either be vented directly to atmosphere or into an optional common condenser, but if toxic emissions are present in said excess gases then said excess gases are vented into said condenser to enable said toxic emissions to be cooled and condensed and the condensate and any incondensible gases emerging from said condenser to be de-toxified, whereby, as an alternative to venting said excess gases containing toxic emissions into said condenser, said excess gases may be vented into said combustor and said toxic emissions destroyed by combusting them therein.

A further alternate form of apparatus for continuous processing of moist materials according to the invention comprises a loading enclosure, a drying enclosure, at least one processing enclosure, a cooling enclosure and an unloading enclosure, said loading enclosure, drying enclosure, at least one processing enclosure, cooling enclosure and unloading enclosure being separable from each other by means of preferably sliding, and when dosed airtight doors and said loading enclosure and said unloading enclosure being separable from the exterior of said further alternate form of apparatus by means of preferably sliding, and when closed airtight loading and unloading doors.

Each said drying, processing and cooling enclosure has a separate recirculation path passing through it whereby, in use, individual containers loaded with moist material are conveyed sequentially first through said preferably sliding and when closed airtight loading door into said loading enclosure, then through one of said preferably sliding and when closed airtight doors into said drying enclosure within which said moist material is dried, then through another said preferably sliding and when closed airtight door into said at least one processing enclosure within which said dried material is processed, then through another said preferably sliding and when closed airtight door into said cooling enclosure within which said solid residues are cooled, then through another said preferably sliding and when closed airtight door into said unloading enclosure and then through said preferably sliding and when closed airtight unloading door, whereby, in use, while dried material is being processed in said processing enclosure, the venting of the excess gases generated from said dried material being processed into a combustor may enable the thermal energy generated by their combustion to provide at least some of the thermal energy required for the drying and processing of said moist material.

The following is a more detailed description of embodiments of the invention, by way of example, reference being made to the accompanying drawings in which:

FIG. 1 is a plan view outline representation of a basic form of continuous drying, processing and cooling apparatus according to the invention,

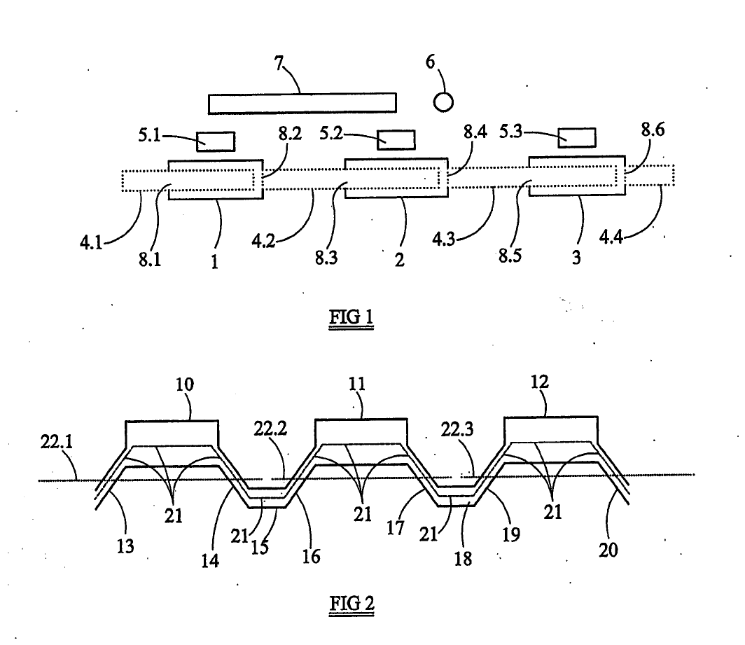

FIG. 2 is a side view sectional representation of said basic form of continuous drying, processing and cooling apparatus according to the invention,

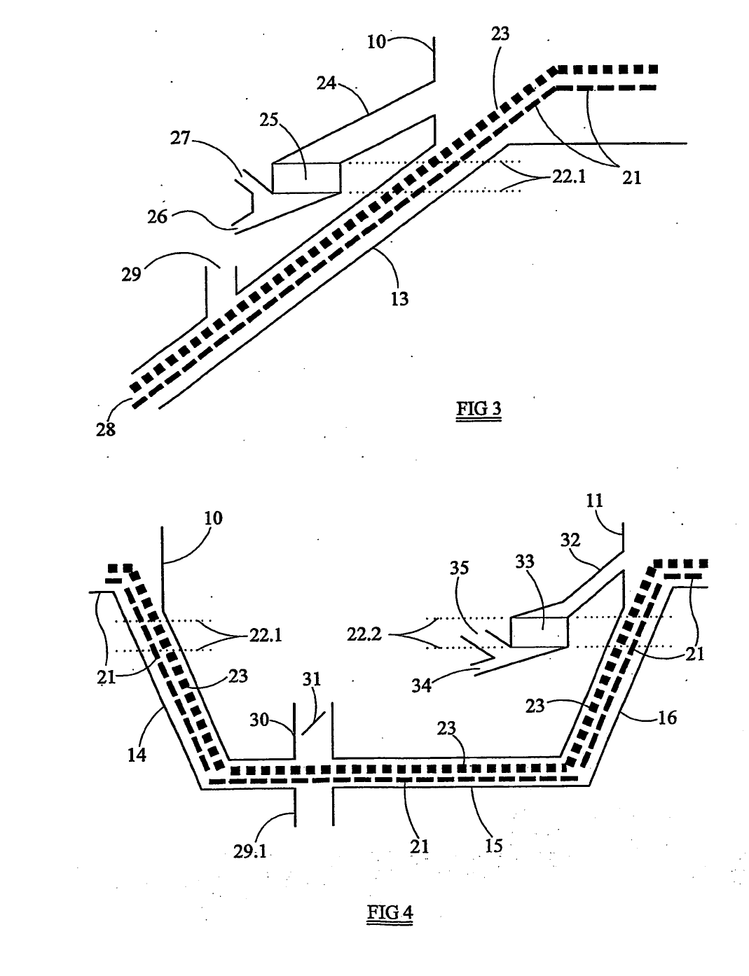

FIGS. 3-6 are more detailed side view sectional representations of elements of the said basic form of continuous drying, processing and cooling apparatus according to the invention,

FIGS. 7-9 are end view sectional representations of the drying, processing and cooling enclosures respectively,

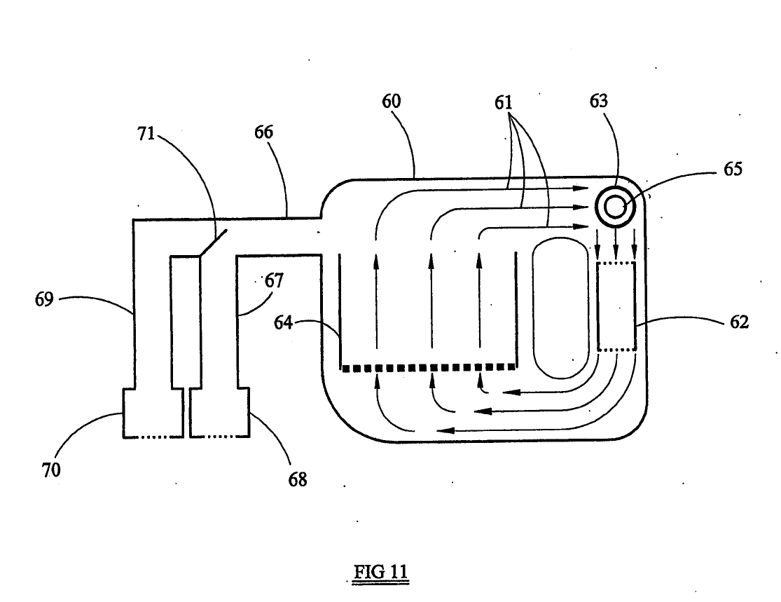

FIG. 10 is an end view section representation of an alternate form of the cooling enclosure.

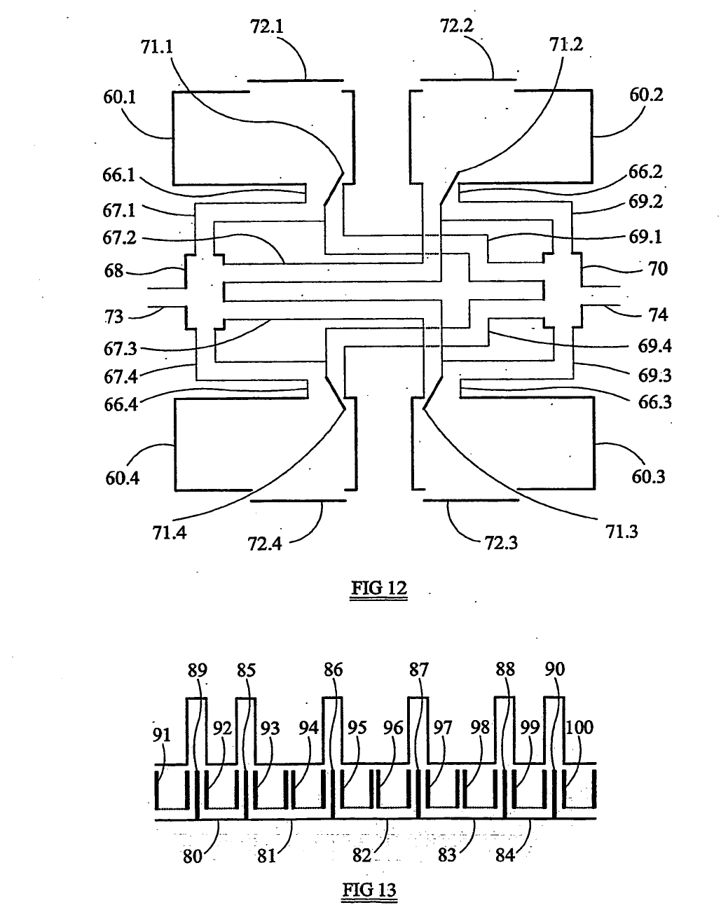

FIGS. 11 and 12 are side and plan view representations respectively of alternative apparatus according to the invention, and

FIG. 13 is a side view representation of a further alternative apparatus according to the invention.

Referring to FIG. 1, there is shown diagrammatically in plan view an outline representation of an apparatus for continuous drying of moist organic material in superheated steam, processing the dried material in hot process gases and cooling its hot solid residues in an inert gas, preferably but not exclusively superheated steam, comprising a drying enclosure 1, at least one processing enclosure 2 and a cooling enclosure 3, conveying means 4.1, 4.2 and 4.3 passing into and through said enclosures 1, 2 and 3 respectively and conveying means 4.4 passing out of said enclosure 3 through not shown ducts, said ducts either communicating with or linking said enclosures 1, 2 and 3, said enclosures 1, 2 and 3 and said not shown ducts being thermally insulated, whereby, except where mentioned hereafter by reference to FIGS. 2 to 10, said enclosures 1, 2 and 3 and said not shown ducts, and their junctions with said enclosures at the locations indicated by 8.1, 8.2, 8.3, 8.4, 8.5 and 8.6, are all airtight.

During an initial warm-up period the drying enclosure 1 is heated by recirculating the ambient air atmosphere initially contained in said drying enclosure 1 over at least one indirect heater 7 by means of a not shown recirculation fan while moist material begins to be transported by conveying means 4.1 into and through the drying enclosure 1 in which the recirculating ambient air atmosphere is displaced and replaced by recirculating superheated steam generated from the moisture in the material by the known method described in Specification No. 2281383, said recirculating superheated steam then completing the drying of the material as described in Specification No. 2281383 before it is transported out of the drying enclosure 1 and into the at least one processing enclosure 2 by the conveying means 4.2, whereby, in use, the additional steam generated from the moisture in said material is vented, preferably but not exclusively into a condenser or cooler 5.1.

Before the dried material begins to be transported from the drying enclosure 1 into the at least one processing enclosure 2 by the conveying means 4.2, warm-up of said at least one processing enclosure 2 is initiated by recirculating the ambient air atmosphere initially contained in said at least one processing enclosure 2 over at least one indirect heater 7 by means of a not shown recirculation fan and, once the temperature of the air in said processing enclosure 2 exceeds 100° C., said air may be displaced and replaced either by an externally provided inert gas atmosphere or, by temporarily venting some or all of the steam being generated in the drying enclosure 1 via a not shown dampered duct into said at least one processing enclosure 2 instead of venting it preferably but not exclusively into said condenser or cooler 5.1, by a superheated steam atmosphere, whereby, in use, said air, said externally provided inert gas atmosphere or said superheated steam atmosphere then contained in said at least one processing enclosure 2 is heated to a temperature above that at which drying in superheated steam is proceeding in drying enclosure 1 by recirculating said externally provided inert gas atmosphere or said superheated steam atmosphere over the at least one indirect heater 7 and through said at least one processing enclosure 2 by means of said not shown recirculation fan.

As the dried material begins to be transported through said at least one processing enclosure 2 and processed at said temperature above that at which drying in superheated steam is proceeding in drying enclosure 1, hot process gases generated from said dried material displace and replace the air, inert gas or superheated steam atmosphere in said at least one processing enclosure 2, following which heating and processing of the said dried material proceeds by recirculating said hot process gases over said at least one indirect heater 7 and through said dried material in said at least one processing enclosure 2 by means of said not shown recirculation fan, whereby, in use, said temperature above that at which drying in superheated steam is proceeding in drying enclosure 1 is maintained and the additional hot process gases generated from said dried material being transported through and processed in said at least one processing enclosure 2 are vented either into a condenser or cooler 5.2 or, when said additional hot process gases are combustible, into a combustor 6, while any combustible incondensible gases which emerge from any said condenser or cooler 5.2 are ducted into said combustor 6, and said at least one indirect heater 7 may be heated by the combustion gases generated by the combustion of said additional hot process gases and the said combustible incondensible gases in said combustor 6.

Before the hot solid residues remaining after hot process gases have been generated from said dried material begin to be transported from said at least one processing enclosure 2 into the cooling enclosure 3 by the conveying means 4.3, replacement of the ambient air atmosphere initially contained in said cooling enclosure 3 may be carried out, either by recirculating said ambient air atmosphere initially contained in said cooling enclosure 3 over said at least one indirect heater 7 by means of a not shown recirculation fan in order to heat it or, for example, by heating said ambient air atmosphere by arranging for a portion of the flue gases emerging from said at least one indirect heater 7 to enter said cooling enclosure 3, whereby, in use, once the temperature of the air or air with a portion of flue gas in said cooling enclosure 3 exceeds 100° C., said ambient air or air with a portion of flue gas atmosphere may be displaced and replaced by a superheated steam atmosphere by temporarily venting some or all of the additional steam being generated in said drying enclosure 1 via a not shown dampered duct into said cooling enclosure 3 instead of venting said additional steam preferably into said condenser or cooler 5.1 or, alternately, the said ambient air atmosphere initially contained in said cooling enclosure 3 may be displaced and replaced by an externally provided inert gas atmosphere.

When the said atmosphere in said cooling enclosure 3 is ambient air, as the said hot solid residues are transported through said ambient air atmosphere in said cooling enclosure 3, limited combustion of a small portion of said hot solid residues occurs and said air atmosphere is displaced and replaced by the hot and virtually oxygen-free combustion gas produced. Thereafter said hot and virtually oxygen-free combustion gas is recirculated by said not shown recirculation fan through said cooling enclosure 3 and through a condenser or cooler 5.3 in which any condensable components in any further hot process gases generated from said hot solid residues while said hot solid residues are being transported through said hot and virtually oxygen-free atmosphere in said cooling enclosure 3 are condensed and said hot and virtually oxygen-free combustion gas and any incondensible components in any further hot process gases generated from said hot solid residues cooled to slightly above 100° C., whereby, in use, on their return to said cooling enclosure 3, the thus cooled combustion gas and any incondensible components in any said further hot process gases generated from said hot solid residues in turn cool said hot solid residues before they are transported out of said cooling enclosure 3 into ambient air by said conveying means 4.4.

When the said atmosphere in said cooling enclosure 3 is superheated steam, as the said hot solid residues are transported through said superheated steam atmosphere in said cooling enclosure 3, said superheated steam is recirculated by a not shown recirculation fan through said cooling enclosure 3 into which atomised cooling water is injected, preferably into the eye of said not shown recirculation fan, at a rate sufficient to cool said superheated steam to slightly above 100° C., whereby, in use, the additional steam generated in said cooling enclosure 3 from said atomised cooling water and any further hot process gases generated from said hot solid residues while said hot solid residues are being transported through said superheated steam atmosphere in said cooling enclosure 3 are vented into a condenser or cooler 5.3 and said additional steam and any condensable components in any said further hot process gases generated from said hot solid residues are condensed in said condenser or cooler 5.3, while the thus cooled recirculating superheated steam and any incondensible components in said hot process gases in turn cool said hot solid residues before they are transported out of said cooling enclosure 3 into ambient air by said conveying means 4.4.

When the said atmosphere in said cooling enclosure 3 is an inert gas other than superheated steam, as said hot solid residues are transported through said inert gas atmosphere in said cooling enclosure 3, said inert gas is recirculated by a not shown fan through said cooling enclosure 3 and through said condenser or cooler 5.3 in which any condensable components in any further hot process gases generated from said hot solid residues while said hot solid residues are being transported through said inert gas atmosphere in said cooling enclosure 3 are condensed and said inert gas and any incondensible components in any said further hot process gases generated from said hot solid residues while said hot solid residues are being transported through said inert gas atmosphere in said cooling enclosure 3 are cooled to slightly above 100° C., whereby, in use, on their return to said cooling enclosure 3 the thus cooled inert gas and any incondensible components in any said further hot process gases generated from said hot solid residues in turn cool said hot solid residues before they are transported out of said cooling enclosure 3 into ambient air by said conveying means 4.4.

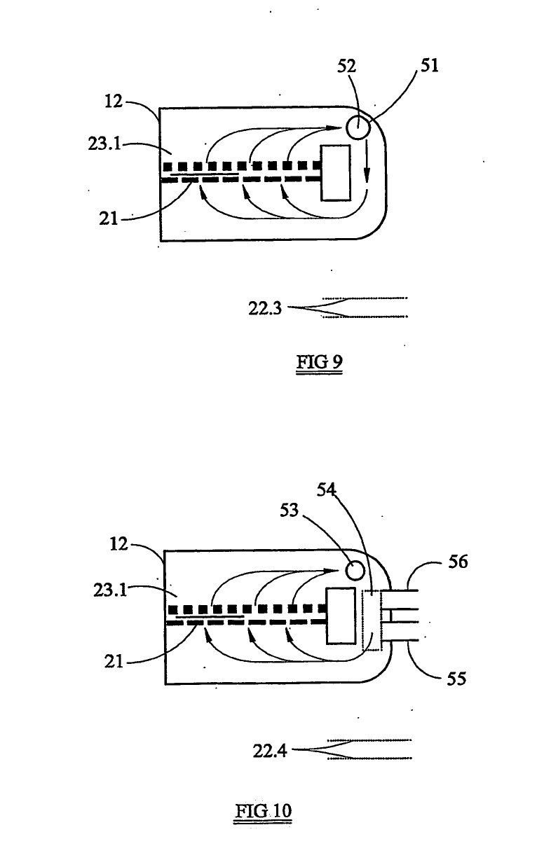

After completion of said initial warm-up period, said conveying means 4.1 continue to transport the moist material out of ambient air, upwards through a steam/air stratification layer seal and into and through said superheated steam atmosphere in said drying enclosure 1, while said conveying means 4.2 continue to transport the dried material out of said superheated steam atmosphere in said drying enclosure 1, downwards through a steam/air stratification layer seal and through ambient air before transporting said dried material upwards through a hot process gases/air stratification layer seal and into and through said hot process gases atmosphere in said at least one processing enclosure 2, while said conveying means 4.3 continue to transport the processed material's then hot solid residues out of said hot process gases atmosphere in said at least one processing enclosure 2, downwards through a hot process gases/air stratification layer seal and through ambient air before transporting said hot solid residues upwards through either a virtually oxygen-free combustion gas/air, superheated steam/air or other inert gas/air stratification layer seal and into and through a slightly above 100° C. combustion gas, superheated steam or other inert gas atmosphere in said cooling enclosure 3 and said conveying means 4.4 transport the then cooled solid residues out of said slightly above 100° C. combustion gas, superheated steam or other inert gas atmosphere in said cooling enclosure 3, downwards through a combustion gas, superheated steam or other inert gas/air stratification layer seal and into ambient air, all as further described by reference to FIGS. 2 to 6, whereby, in use, the said steam/air, hot process gases/air and combustion gas, steam or other inert gas/air stratification layer seals, which prevent the escape of superheated steam, hot process gases, combustion gas, superheated steam and/or other inert gas respectively from said drying, processing and cooling enclosures 1, 2 and 3 respectively or the entry of air into said enclosures, are created and maintained naturally due to the densities of said above 100° C. steam, hot process gases, combustion gas and superheated steam or other inert gas atmospheres respectively above the said stratification layer seals being significantly less than that of ambient air, and the required above 100° C. drying and processing temperatures of said superheated steam in said drying enclosure 1 and of said hot process gases in said processing enclosure 2 are maintained by continuing separately to recirculate said superheated steam and said hot process gases over said at least one indirect heater 7 by means of said not shown recirculation fans, and the slightly above 100° C. temperature of the said combustion gas, superheated steam or other inert gas in said cooling enclosure 3, which is increased by heat transfer from said hot solid residues into the slightly above 100° C. superheated steam, or combustion gas or other inert gas atmosphere respectively in said cooling enclosure 3 as said hot solid residues are being transported through said cooling enclosure 3, is again reduced to slightly above 100° C. as described by reference to FIG. 9 and FIG. 10 respectively, and the denser of said superheated steam in said drying enclosure 1, said hot process gases in said processing enclosure 2 and said combustion gas, superheated steam or other inert gas in said cooling enclosure 3, all having differing densities below that of ambient air, are prevented by said steam/air, hot process gases/air and combustion gas, steam or other inert gas/air stratification layer seals from passing through said not shown ducts linking said enclosures 1, 2 and 3 into an adjoining drying, processing or cooling enclosure 1, 2 or 3.

At the commencement of said initial warm-up period the heating medium employed in the at least one indirect heater 7 is combustion gases produced in said combustor 6 by burning an externally supplied fuel, but during or after said warm-up period the use of such externally supplied fuel may be reduced or eliminated as and when the thermal energy released by combusting the hot process gases vented directly into said combustor 6 from said at least one processing enclosure 2 and/or the incondensible gases emerging from any or all of said at least one condenser or cooler 5.1, 5.2 and 5.3 becomes sufficient or more than sufficient to reduce or eliminate the use of such externally supplied fuel, whereby, in use, if more than sufficient thermal energy is released by combusting the hot process gases vented directly to said combustor 6 from said at least one processing enclosure 2 and/or the incondensible gases emerging from any or all of said at least one condenser or cooler 5.1, 5.2 and 5.3 than is required by said at least one indirect heater 7 then most of any excess combustion gases may be employed to heat additional apparatus, preferably but not exclusively apparatus similar to that herein described

Referring to FIG. 2, there is shown diagrammatically a side view sectional representation of an apparatus in principle according to FIG. 1 comprising drying, processing and cooling enclosures 10, 11 and 12 respectively, an inlet duct 13, open to atmosphere at its base, leading upwardly into the drying enclosure 10 at one end thereof, an outlet duct 14 leading downwardly away from the opposite end of said drying enclosure 10, a transfer duct 15 with at least one not shown opening to atmosphere, an inlet duct 16 leading upwardly from said transfer duct 15 into the processing enclosure 11 at one end thereof, an outlet duct 17 leading downwardly away from the opposite end of said processing enclosure 11, a transfer duct 18 with at least one not shown opening to atmosphere, an inlet duct 19 leading upwardly from said transfer duct 18 into the cooling enclosure 12 at one end thereof and an outlet duct 20, open to atmosphere at its base, leading downwardly away from the opposite end of said cooling enclosure 12, said transfer duct 15 being joined in airtight manner to said ducts 14 and 16 and said transfer duct 18 being joined in airtight manner to said ducts 17 and 19, whereby, in use, due to the bases of both said inlet duct 13 and said outlet duct 20 being open to atmosphere and said transfer ducts 15 and 18 having not shown openings to atmosphere, the gases contained in said enclosures 10, 11 and 12 are at atmospheric pressure.

Conveying means 21 of designs appropriate to each material to be dried, processed and cooled are provided to transport said material first upwards through said inlet duct 13 and through said drying enclosure 10, then downwards, then preferably but not exclusively horizontally and then upwards through said ducts 14, 15 and 16 respectively and through said processing enclosure 11, then downwards, then preferably but not exclusively horizontally and then upwards through said ducts 17, 18 and 19 respectively and through said cooling enclosure 12 and finally downwards through said outlet duct 20.

After the said initial warm-up period when said material (shown indicatively as 23 in FIG. 3) is being dried above the level 22.1 of effectively substantially gas-tight steam/air stratification layer seals across said ducts 13 and 14 and is being transported into, through or out of said drying enclosure 10 it is passing through superheated steam whereas when said material, having been dried, is being processed above the level 22.2 of effectively substantially gas-tight hot process gases/air stratification layer seals across said ducts 16 and 17 and is being transported into, through or out of said processing enclosure 11 said material is passing through hot process gases and when said material's solid residues (shown indicatively as 23.1 in FIG. 5) are being cooled above the level 22.3 of effectively substantially gas-tight combustion gas, steam or inert gas/air stratification layer seals across said ducts 19 and 20 and are being transported into, through or out of said cooling enclosure 12 said solid residues are passing either through combustion gas, superheated steam or other inert gas, whereas, when said material is below said levels 22.1 and 22.2 of said effectively substantially gas-tight steam/air or hot process gases/air stratification layer seals across said ducts 13, 14, 16 and 17 respectively, and when said solid residues are below said level 22.3 of the said effectively substantially gas-tight combustion gas/air, steam/air or inert gas/air stratification layer seals across said ducts 19 and 20 respectively, said material and said solid residues are passing from, through or into ambient air, whereby, in use, said ambient air in said ducts 13 and 14 may contain a small proportion of steam, said ambient air in ducts 16 and 17 may contain a small proportion of process gases and said ambient air in ducts 19 and 20 may contain a small proportion of process gases, combustion gas, steam and/or inert gas, and said levels 22.1 and 22.2 of said effectively substantially gas-tight steam/air or hot process gases/air stratification layer seals across said ducts 13, 14, 16 and 17 respectively, and said level 22.3 of the said effectively substantially gas-tight combustion gas/air, steam/air or inert gas/air stratification layer seals across said ducts 19 and 20 respectively, are substantially identical.

Other forms of the apparatus may include at least one additional not shown processing enclosure located between said enclosures 11 and 12, any such additional enclosure being linked by further ducts corresponding to said ducts 17, 18 and 19 to said enclosures 11 and 12.

When there is one or more additional processing enclosure, said further ducts corresponding to said ducts 17, 18 and 19 are provided to link the then two or more processing enclosures to each other, whereby, in use, when said material is above said level 22.2 of said effectively substantially gas-tight hot process gases/air stratification layer seals across said further ducts corresponding to said ducts 17 and 19 while being transported into, through or out of said one or more additional enclosures corresponding to said enclosure 12 said material is being transported through hot process gases, and when said material is below said level 22.2 of said effectively substantially gas-tight hot process gases/air stratification layer seals across any further ducts corresponding to said ducts 17, 18 and 19 said material is passing through ambient air.

Referring to FIG. 3, there is shown diagrammatically a side view sectional representation of part of the material inlet end of the drying enclosure 10 included in FIG. 2 showing an inlet duct 13 communicating with and joined in airtight manner to said drying enclosure 10, conveying means 21 passing through said inlet duct 13 and through said drying enclosure 10 respectively and the level 22.1 of said steam/air stratification layer seal across said inlet duct 13.

Moist material 23 is transported upwards through said inlet duct 13 by said conveying means 21 and enters the superheated steam atmosphere in said drying enclosure 10 as it is conveyed to above said level 22.1 of the steam/air stratification layer seal, said level 22.1 being dictated as described in said Specification No. 2281383 by the level of a condenser 25 which receives the additional steam generated by the drying process taking place in said drying enclosure 10 through a vent 24 and converts it to condensate which is then recovered through the condensate drain 26, whereby, in use, said additional steam received by said condenser 25 is kept at atmospheric pressure by means of a vent 27 through which any incondensible gases vented from the dryer with said additional steam emerge and may either be included with the combustion air required by the combustor shown as 6 in FIG. 1 or released to atmosphere at said level 22.1, after scrubbing or any other cleansing process which may be necessary, while said condenser 25 is cooled by not shown passage of a cooling medium, preferably but not exclusively air or water, into, through and out of said condenser 25.

To prevent any steam or other gases which may descend from said drying enclosure through said inlet duct 13 to below said level 22.1 of said steam/air stratification layer seal across said inlet duct 13 emerging to atmosphere through the open base 28 of said inlet duct 13, a portion of the combustion air required by the combustor 6 shown in FIG. 1 is drawn upwards through said open base 28 of said inlet duct 13 and leaves said inlet duct 12 through a vent 29 leading into said combustor 6 at said level 22.1, whereby, in use, any such steam and any other gases which may descend through said inlet duct 13 from said drying enclosure 10 are entrained into said combustor 6 with said portion of the combustion air instead of emerging to atmosphere through said open base 28 of said drying enclosure 10.

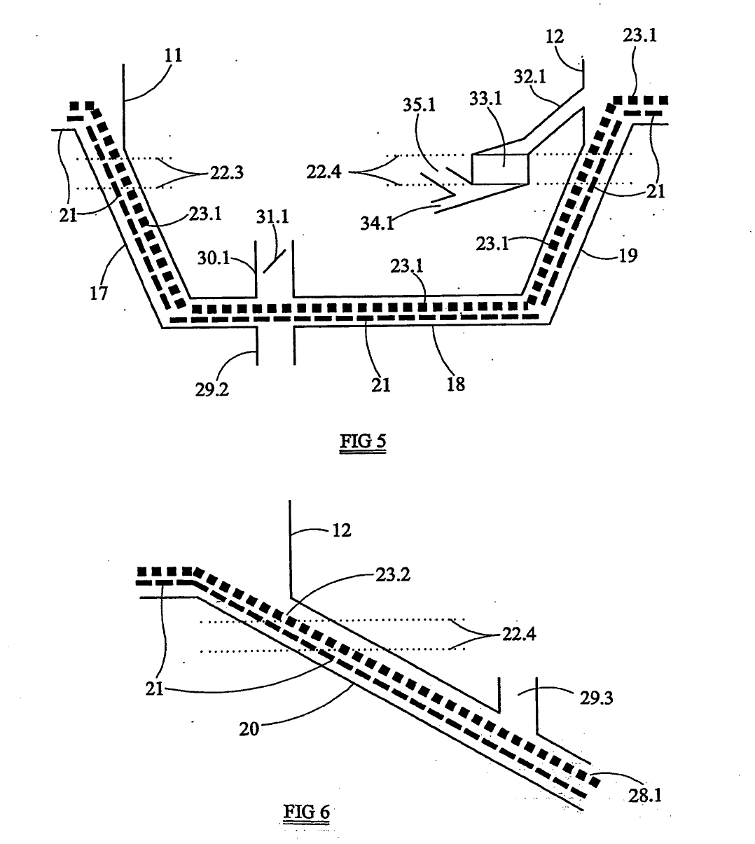

Referring to FIG. 4, there is shown diagrammatically a side view sectional representation of part of the material outlet end of said drying enclosure 10, showing an outlet duct 14 communicating with and joined in airtight manner to said drying enclosure 10, a transfer duct 15 communicating with and joined in airtight manner to said outlet duct 14 and communicating with and joined in airtight manner to an inlet duct 16 communicating with and joined in airtight manner to a processing enclosure 11, part of the material inlet end of said processing enclosure 11 being shown, conveying means 21 passing through said ducts 14, 15 and 16, and levels 22.1 and 22.2 of the steam/air and hot process gases/air stratification layer seals across said outlet duct 14 and said inlet duct 16 respectively, all generally as described by reference to FIG. 2, and dried material 23 being conveyed by said conveying means 21 from said drying enclosure 10, through said ducts 14, 15 and 16 into said processing enclosure 11.

To ensure that atmospheric pressure is maintained in said outlet duct 14, transfer duct 15 and inlet duct 16 and that air is present in them below the level of said stratification layer seals 22.1 and 22.2, and to prevent any steam or other gases which may descend from the drying enclosure 10 through said outlet duct 14 to below said level 22.1 of the steam/air stratification layer seal across said outlet duct 14 passing through said transfer duct 15 and said inlet duct 16 into said processing enclosure 11, and to prevent any hot process gases which may descend from said processing enclosure 11 through said inlet duct 16 to below said level 22.2 of said hot process gases/air stratification layer seal across said inlet duct 16 passing through said transfer duct 15 and said inlet duct 16 into said drying enclosure 10, a further portion of combustion air is drawn upwards through an ambient air entry duct 29.1, passes upwards across said transfer duct 15 and through said conveying means 21 and said hot dried material 23 being transported by said conveying means 21, by upwards convection into an exhaust duct 30 leading into said combustor shown as 6 in FIG. 1 at said level 22.2, whereby, in use, any steam or other gases which may descend from said drying enclosure 10 through said outlet duct 14 into said transfer duct 15 and any hot process gases which may descend from said processing enclosure 11 through said inlet duct 16 into said transfer duct 15, together with any hot gases which may be emitted from said dried material 23 while said material is below said levels 22.1 and 22.2 of the said stratification layer seals, are entrained with said further portion of combustion air and ducted through said exhaust duct 30 into the said combustor 6 at said level of 22.2 across the said inlet duct 16.

Not shown thermocouples in said ambient air entry duct 29.1 and in said exhaust duct 30 control the opening of a damper 31 located in said exhaust duct 30, either by tending to open said damper 31 if the temperature in said ambient air entry duct 29.1 rises, indicating an outflow through said ambient air entry duct 29.1 of any hot gases which may be emitted from said dried material 23 being transported through said transfer duct 15 and/or of steam or of hot process gases moving downwards through said outlet duct 14 or said inlet duct 16 respectively, or by tending to close said damper 31 if the temperature in said exhaust duct 30 either falls, indicating that more air than is necessary is entering said ambient air entry duct 29.1 and passing upwards across said transfer duct 15 and through said conveying means 21 and said hot dried material 23 being transported by said conveying means 21, by upwards convection through said exhaust duct 30 leading said further portion of the combustion air to said combustor 6, or rises excessively, indicating that unwanted ignition of said hot dry material 23 is beginning to take place and requiring the fire to be extinguished by reducing the amount of air entering said ambient air entry duct 29.1, whereby, in use, the volume of air entering said ambient air entry duct 29.1 is sufficient, but not more than sufficient to entrain any hot gases which may be emitted from said dried material 23, any steam or other gases which might descend from said drying enclosure 10 and any hot process gases which might descend from said processing enclosure 11 through said exhaust duct 30 and into the said combustor 6.

Referring again to FIG. 4, additional hot process gases generated from said hot dry material 23 while it is being processed during its passage through the hot process gases contained in said processing enclosure 11 are emitted through a vent 32 shown leading downwardly from said processing enclosure 11 towards said level 22.2 of the hot process gases/air stratification layer seal across said inlet duct 16, whereby, in use, when commercially viable, condensable components in said additional hot process gases generated from said hot dry material 23 emitted through said vent 32 while said hot dry material 23 is being processed in said processing enclosure 11 are condensed in a condenser 33 and the condensate recovered as it emerges through a drain 34, while any incondensible components in said hot process gases are vented through a vent 35 into the said combustor 6 at said level 22.2 of the hot process gases/air stratification layer seal across said inlet duct 16 or, when such recovery of condensable components is not commercially viable, said condenser 33, drain 34 and vent 35 are omitted from the apparatus and said vent 32 arranged to deliver all of the said additional hot process gases generated from said hot dry material 23 into said combustor 6 at said level 22.2 of said hot process gases/air stratification layer seal across said inlet duct 16.

Again referring to FIG. 4, if more than one processing enclosure 11 is provided then the above description of the apparatus between said drying enclosure 10 and said processing enclosure 11 will apply except that, instead of a steam/air there will be a hot process gases/air stratification layer seal at a level corresponding to said level 22.2 across the outlet duct from any preceding processing enclosure and instead of steam or other gases it will be hot process gases which might descend through said outlet duct from each preceding processing enclosure to below said level 22.2, while instead of hot dry material, processed material will be passing through the outlet, transfer and inlet ducts located between each preceding and each successive processing enclosure.

Referring to FIG. 5, there is shown diagrammatically a side view sectional representation of part of the material outlet end of the last of the one or more said processing enclosures 11, showing an outlet duct 17 communicating with and joined in airtight manner to said last processing enclosure 11, a transfer duct 18 communicating with and joined in airtight manner to said outlet duct 17 and communicating with and joined in airtight manner to said inlet duct 19 communicating with and joined in airtight manner to a cooling enclosure 12, part of the input end of said cooling enclosure 12 being shown, conveying means 21 conveying hot solid residues 23.1 from said processing enclosure 11, through said ducts 17, 18 and 19 and into said cooling enclosure 12, and levels 22.3 and 22.4 of the hot process gases/air and combustion gas/air, steam/air or inert gas/air stratification layer seals across said outlet duct 17 and said inlet duct 19 respectively, all generally as described by reference to FIG. 2, and hot solid residues 23.1 of the processed material being conveyed by said conveying means 21 from said processing enclosure 11, through said ducts 17, 18 and 19 into said cooling enclosure 12.

To ensure that atmospheric pressure is maintained in said outlet duct 17, transfer duct 18 and inlet duct 19 and that air is present in them below the level of said stratification layer seals 22.3 and 22.4, and to prevent any hot process gases which may descend from said processing enclosure 11 through said outlet duct 17 to below said level 22.3 of said process gases/air stratification layer seal across said outlet duct 17 passing through said transfer duct 18 and said inlet duct 19 into said cooling enclosure 12, and to prevent any combustion gas, steam or other inert cooling gas which may descend from said cooling enclosure 12 through said inlet duct 19 to below said level 22.4 of said combustion gas, steam or other inert cooling gas/air stratification layer seal across said inlet duct 19 passing through said transfer duct 18 and said outlet duct 17 into said processing enclosure 11, a further portion of combustion air is drawn upwards through an ambient air entry duct 29.2, passes upwards across said transfer duct 18 and through said conveying means 21 and said hot solid residues 23.1 being transported by said conveying means 21, by upwards convection into said exhaust duct 30.1 leading to the combustor shown as 6 in FIG. 1, whereby, in use, any hot process gases which may descend from said processing enclosure 11 through said duct 17 into said transfer duct 18 and any combustion gas, steam or other inert cooling gas which may descend from said cooling enclosure 12 through said duct 19 into said transfer duct 18, together with any hot process gases which may be emitted from said hot solid residues 23.1 while said hot solid residues are below the levels 22.3 and 22.4 of the said stratification layer seals, are entraining with said further portion of combustion air and ducted through said exhaust duct 30 into said combustor 6 at said level 22.3 of said hot process gases/air stratification layer seal across the said inlet duct 16.

Not shown thermocouples in said air entry duct 29.2 and in said exhaust duct 30.1 control the opening of a damper 31.1 located in said exhaust duct 30.1, either by tending to open said damper 31.1 if the temperature in said ambient air entry duct 29.2 rises, indicating an outflow through said ambient air entry duct 29.2 of any hot process gases which may be emitted from said hot solid residues 23.1 being transported through said transfer duct 18 and/or of hot process gases and/or of steam and/or of said other inert cooling gas/air moving downwards through said outlet duct 17 and/or said inlet duct 19 respectively, or by tending to close said damper 31.1 if the temperature in said exhaust duct 30.1 either falls, indicating that more air than is necessary is entering through said ambient air entry duct 29.2 and passing upwards across said transfer duct 18 and through said conveying means 21 and said hot solid residues 23.1 being transported by said conveying means 21, by upwards convection through said exhaust duct 30.1 leading said further portion of the combustion air into said combustor 6 at said level 22.4, or rises excessively, indicating that unwanted ignition of said hot solid residues 23.1 is beginning to take place and requiring the fire to be extinguished by reducing the amount of air entering said ambient air entry duct 29.2, whereby, in use, the volume of air entering said ambient air entry duct 29.2 is sufficient, but not more than sufficient to entrain any hot process gases which may be emitted from said hot solid residues 23.1, any hot process gas which might descend from said processing enclosure 11 and any combustion gas, steam or other inert cooling gas which might descend from said cooling enclosure 12, and any combustion gas generated by any unwanted ignition of said hot solid residues 23.1, through said exhaust duct 30.1 and into said combustor 6.

Referring again to FIG. 5, when the atmosphere contained in said cooling enclosure 12 is combustion gas or other inert gas, if any additional hot process gases are generated from said hot solid residues 23.1 as they are cooled during their passage through said combustion gas or other inert cooling gas atmosphere contained in said cooling enclosure 12, a portion of any such additional hot process gases together with a portion of said cooling enclosure 12's combustion gas or other inert cooling gas atmosphere is emitted as a gaseous mixture through a vent 32.1 shown leading downwardly from said cooling enclosure 12 towards said level 22.4 of a combustion gas or other inert cooling gas/air stratification layer seal across said inlet duct 19, whereby, in use, any volume of said gaseous mixture emitted through said vent 32.1 equates to that of any said additional hot process gases generated from said hot solid residues 23.1.

Any components in any said volume of said gaseous mixture emitted through said vent 32.1 which are condensable at slightly below 100° C. may either be condensed in a condenser or cooler 33.1 and the condensate recovered as it emerges through a drain 34.1, while the incondensible components in any said volume of said gaseous mixture emitted through said vent 32.1 may be vented through a vent 35.1 into said combustor 6 at said level 22.4 of said cooling gas/air stratification layer seal across said inlet duct 19, or said condenser or cooler 33.1, drain 34.1 and vent 35.1 may be omitted from said apparatus and any said volume of said gaseous mixture emitted through said vent 32.1 may then be vented directly into said combustor 6 at said level 22.4 of said cooling gas/air stratification layer seal across said inlet duct 19, whereby, in use, if any additional process gases are generated from said hot solid residues 23.1 as they are cooled during their passage through said combustion gas or other inert cooling gas atmosphere contained in said cooling enclosure 12, the combustion gas or other inert gas atmosphere in said cooling enclosure 12 contains an increasing proportion of said hot process gases.

Referring again to FIG. 5, when the atmosphere contained in said cooling enclosure is superheated steam, if any additional hot process gases are generated from said hot solid residues 23.1 as they are cooled during their passage through said combustion gas or other inert cooling gas atmosphere contained in said cooling enclosure 12, the additional steam generated from the atomised water injected into said cooling enclosure 12 as described by reference to FIG 9 and a portion of any such additional hot process gases are emitted as a gaseous mixture through said vent 32.1 shown leading downwardly from said cooling enclosure 12 towards said level 22.4 of a steam/air stratification layer seal across said inlet duct 19, whereby, in use, the volume of said gaseous mixture emitted through said vent 32.1 equates to that of said additional steam generated from the atomised water injected into said cooling enclosure 12 together with that of said portion of any such additional hot process gases generated from said hot solid residues 23.1.

Said additional steam together with any components in said portion of any such additional hot process gases emitted through said vent 32.1 which are condensable at or below 100° C. may then be condensed in said condenser or cooler 33.1 and the condensate recovered as it emerges through a drain 34.1, while any components in any said portion of any such additional hot process gases emitted through said vent 32.1 which are incondensible at or below 100° C. may then be vented through said vent 35.1 into said combustor 6 at said level 22.4 of said cooling gas/air stratification layer seal across said inlet duct 19, whereby, in use, if any such additional hot process gases are gases generated from said hot solid residues 23.1 while said hot solid residues 23.1 are being cooled in said cooling enclosure 12, said superheated steam atmosphere in said cooling enclosure 12 will contain a small proportion of any such additional process gases.

Referring again to FIGS. 4 and 5, when in practice there is no significant tendency for steam or other gases to pass from said drying enclosure 10 through said ducts 14, 15 and 16 respectively into said processing enclosure 11, or for hot process gases to pass from said processing enclosure 11 either through said ducts 16, 15 and 14 respectively into said drying enclosure 10 or through said ducts 17, 18 and 19 respectively into said cooling enclosure 12, or for combustion gas, steam or other inert cooling gas to pass from said cooling enclosure 12 through said ducts 19, 18 and 17 respectively into said processing enclosure 11, or such passage of gases or gas can be prevented by baffle or other means, said ambient air entry ducts 29 and/or 29.1, said exhaust ducts 30 and/or 30.1 and said dampers 31 and/or 31.1 and the procedures associated with them may be omitted, whereby, in use, the risk of unwanted ignition of said hot dry material 23 and/or of said hot solid residues 23.1 taking place during their conveyance by said conveying means 21 through said ducts 15 and/or 18 respectively maybe eliminated.

Referring to FIG. 6, there is shown diagrammatically a side view sectional representation of part of the solid residues outlet end of the cooling enclosure 12 included in FIG. 2 showing an outlet duct 20 communicating with and joined in airtight manner to said cooling enclosure 12, conveying means 21 passing through said cooling enclosure 12 and conveying cooled solid residues 23.2 downwardly through said outlet duct 20 and into ambient air, and the level 22.4 of the steam/air or other inert gas/air stratification layer seal across said outlet duct 20.

Cooled solid residues 23.2 are conveyed downwards through said outlet duct 20 by said conveying means 21 and leave the combustion gas, superheated steam or other inert gas atmosphere in said cooling enclosure 12 as said cooled solid residues 23.2 move to below said level 22.4 of said combustion gas, steam or other inert gas/air stratification layer seal, whereby, in use, said level 22.4 is dictated by the level of the condenser or cooler 33.1 shown in, and described by reference to, FIG. 5.

To prevent any combustion gas, steam or other inert gas, or any additional hot process gases generated from the hot solid residues shown as 23.1 in FIG. 5 while they are being cooled in said cooling enclosure 12, which might descend from said cooling enclosure 12 through said outlet duct 20 to below said level 22.4 of the combustion gas, steam or other inert gas/air stratification layer seal across said outlet duct 20, emerging to atmosphere through the open base 28.1 of said outlet duct 20, a further portion of the combustion air required by the combustor shown as 6 in FIG. 1 is drawn upwards through said open base 28.1 of said outlet duct 20 and leaves it through a vent 29.3 leading to said combustor 6, whereby, in use, any such combustion gas, steam or other inert gas and any said additional hot process gases which might descend through said outlet duct 20 are entrained with said further portion of the combustion air into said combustor 6 instead of emerging to atmosphere through said open base 28.1.

Referring again to FIGS. 3 and 6, when in practice there is no significant tendency for steam or other gases to pass from said drying enclosure 10 through said duct 13 and emerge to atmosphere, or for combustion gas, steam or other inert cooling gas to pass from said cooling enclosure 12 through said duct 20 and emerge to atmosphere, or such passage of steam or other gases can be prevented by baffle or other means, said vent 29 and/or said vent 29.3 and the respective procedures associated with them may be omitted, whereby, in use, the said basic form of continuous drying, processing and cooling apparatus according to the invention may be simplified.

Referring to FIG. 7, there is shown diagrammatically an end view sectional representation of the drying enclosure 10 containing, as the drying medium, an above 100° C. superheated steam atmosphere created as described by reference to FIG. 1. Material 23 is conveyed through said drying enclosure 10 by conveying means 21 and dried in said superheated steam atmosphere in said drying enclosure 10 by recirculating said above 100° C. superheated steam atmosphere over at least one indirect heater 7 (first mentioned by reference to FIG. 1) and through said material 23, as indicated by arrows within said drying enclosure 10, by means of a recirculation fan 36, whereby, in use, said at least one indirect heater 7 is heated by a portion of the hot combustion gases produced (as described hereafter) in the combustion chamber 37 of a combustor 6 (also first mentioned by reference to FIG. 1) being drawn from said combustion chamber 37 through an entry duct 38, said at least one indirect heater 7 and an exhaust duct 39, preferably but not exclusively by an extraction fan 40, and the volume of said portion of said hot combustion gases drawn from said combustion chamber through said entry duct 38, said at least one indirect heater 7 and said exhaust duct 39 is controlled by at least one not shown damper in said exhaust duct 39.

As described by reference to FIG. 4, additional hot process gases and/or their incondensible components generated in at least one processing enclosure 11 are vented at atmospheric pressure towards or at the level 22.1 of said at least one processing enclosure 11's hot process gases/air stratification layer seal. Said additional hot process gases and/or their incondensible components are then ducted into said combustor 6 through an entry duct 41 and convect upwards past an adjustable damper 42 with a further portion, or a portion, of combustion air entering through the open base 43 of said combustor 6, whereby, in use, said additional hot process gases and/or their incondensible components and said further portion or portion of combustion air below said adjustable damper 42 and above said open base 43 of said combustor 6 are at atmospheric pressure.

Any portion and further portions of combustion air and other gases described by reference to FIGS. 3, 4, 5, and 6 respectively, together with any additional combustion air required efficiently to combust any combustible components in said other gases, and said additional hot process gases and/or their incondensible components, enter said combustor 6 through a combustion air entry duct 44 and are mixed with said additional hot process gases and/or their incondensible components and said further portion or portion of ambient air entering through said open base 43 of said combustor 6, above said damper 42 and below a grate 45. The resulting gaseous mixture then convects upwards through said grate 45 and into said combustion chamber 37 within which it is ignited and said hot combustion gases produced, whereby, in use, a damper 46 in said combustion air entry duct 44 limits the amount of said additional combustion air entering said combustion air entry duct 44 to that required, with said portion and further portions or portion of combustion air, for efficient combustion of said additional hot gases and/or their incondensible components and of any combustible components in said other gas.

A further portion of said hot combustion gases produced in said combustion chamber 37 may be drawn into and through one or more further entry ducts 38.1 leading to further, not shown apparatus in which the thermal energy in said further portion of said hot combustion gases may be employed, whereby, in use, the required drawing of said portion and further portions of combustion air and other gases described by reference to FIGS. 3, 4, 5, and 6 respectively, said any additional combustion air, said additional hot process gases and/or their incondensble components and said further portion of ambient air entering through said open base 43 of said combustor 6 into said combustion chamber 37 results from the upwards convention of a remaining portion of said hot combustion gases from said combustion chamber 37 to atmosphere through a stack 47, said upwards convection being assisted if necessary by use of a fan indicated by 48 which may be located in said combustion air entry duct 44 and/or of a fan indicated by 49 which may be located in said stack 47.

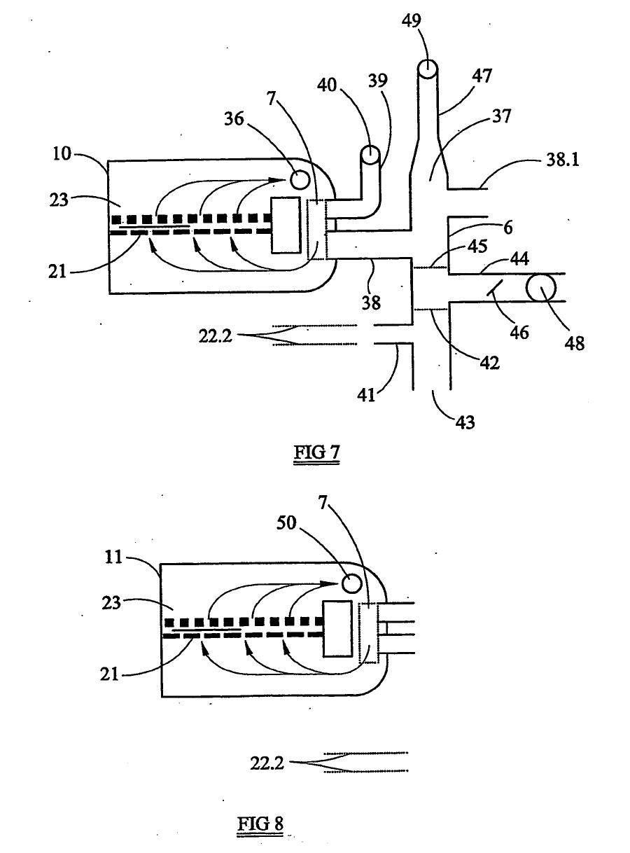

Referring to FIG. 8, there is shown diagrammatically an end view sectional representation of a processing enclosure 11 containing, as the processing medium, a hot process gases atmosphere created as described by reference to FIG. 1.

Dried material 23 is conveyed through said processing enclosure 11 by conveying means 21 and processed in said hot process gas atmosphere by recirculating said hot process gas atmosphere over at least one indirect heater 7 (first mentioned by reference to FIG. 1) and through said material 23, as indicated by arrows within said processing enclosure 11, by means of a recirculation fan 50, whereby, in use, said at least one indirect heater 7 is heated as described by reference to FIG. 7, said hot process gases are heated to a temperature above that at which drying in superheated steam is proceeding in the drying enclosure shown as 10 in FIG. 7, said dried material 23 is processed and, as described in detail by reference to FIG 4, additional hot process gases generated in said processing enclosure 11 are vented at atmospheric pressure from said processing enclosure 11 towards or at the level 22.2 of a hot process gases/air stratification layer seal.

Referring to FIG. 9, there is shown diagrammatically an end view sectional representation of a cooling enclosure 12 containing, as the cooling medium, a slightly above 100° C. superheated steam atmosphere created as described by reference to FIG. 1.

As hot solid residues 23.1 are transported through said cooling enclosure 12 by conveying means 21, said slightly above 100° C. superheated steam atmosphere is recirculated through said hot solid residues 23.1 as indicated by arrows shown within said cooling enclosure 12 by means of a recirculation fan 51, thereby cooling said hot solid residues 23.1 to slightly above 100° C. and heating said superheated steam atmosphere by transfer of thermal energy from said hot solid residues 23.1, whereby, in use, said superheated steam is again cooled to slightly above 100° C. by the controlled injection of atomised water into said enclosure 12, preferably but not exclusively into the eye 52 of said recirculation fan 51, before said superheated steam atmosphere is again recirculated through said hot solid residues 23.1, and, as described in detail by reference to FIG. 5, the additional steam generated from the said atomised water and any further hot process gases which may be emitted from the said hot solid residues during their passage through said cooling enclosure 12 are vented at atmospheric pressure into a condenser or cooler 33.1 located at the level 22.4 of a steam/air stratification layer seal.

Referring to FIG. 10, there is shown diagrammatically an end view sectional representation of a cooling enclosure 12 containing, as the cooling medium, a slightly above 100° C. combustion gas or another inert gas atmosphere created as described by reference to FIG. 1.

As hot solid residues 23.1 are transported through said cooling enclosure 12 by conveying means 21, said slightly above 100° C. combustion gas or other inert gas atmosphere is recirculated through said hot solid residues 23.1 as indicated by arrows shown within said cooling enclosure 12 by means of a recirculation fan 53, thereby cooling said hot solid residues 23.1 to slightly above 100° C. and heating said combustion gas or other inert gas atmosphere by transfer of thermal energy from said hot solid residues 23.1, whereby, in use, said combustion gas or other inert gas atmosphere is again cooled to slightly above 100° C. by passage over a cooler 54 before said combustion gas or other inert gas atmosphere is again recirculated through said hot solid residues 23.1, said cooler 54 is kept cool by passage of a cooling medium, preferably but not exclusively air or water, into, through and out of said cooler 54 via an entry duct 55 and an exit duct 56, and, as described in detail by reference to FIG. 5, a volume of gas equivalent to that of any gases which may be emitted from said hot solid residues during their passage through said cooling enclosure 12 is vented at atmospheric pressure into a condenser or cooler 33.1 located at the level 22.4 of a combustion gas or other inert gas/air stratification layer seal.

In any embodiment of the present invention described by reference to FIGS. 1 to 10 any said conveying means 21 descending through the outlet duct 14, 17 or 20 of any of said drying, processing and cooling enclosures 10, 11 and 12 respectively may be omitted if the material being dried, processed or cooled can without damage be allowed to slide or fall out of such enclosure through any said outlet duct 14, 17 or 20 either onto conveying means 21 located in any or all of the transfer ducts 15 and 18 or through the outlet duct 20 first described by reference to FIG 2.

Referring to FIG. 11, there is shown diagrammatically a side view sectional representation of an alternate apparatus according to the invention comprising at least one drying, processing and cooling enclosure 60, each said drying, processing and cooling enclosure 60 having a recirculation path indicated by arrows 61 within which an indirect heater 62, a recirculation fan 63, at least one container 64 and an atomised water injection nozzle 65 are located, said injection nozzle 65 being able, for example, to direct atomised water preferably but not exclusively into the eye of said recirculation fan 63, whereby, in use, said at least one container 64 is loaded with moist material and inserted into said drying, processing and cooling enclosure 60 through a not shown access door which is then closed in airtight manner. Said moist material is then dried and processed and its solid residues cooled by first recirculating indirectly heated superheated steam through said moist material in order to dry it, then recirculating hot process gases indirectly heated to a higher temperature through the thus dried material in order advantageously to alter its physical properties and/or its chemical composition while recovering or usefully combusting components emitted from it as gases and then recirculating an inert cooling gas through the resulting solid residues in order to cool them, all generally as described by reference to FIG. 1, whereby, in use, instead of said material being transported by conveying means first into and out of a drying enclosure 1, then into and out of a processing enclosure 2 and then, as solid residues, into and out of a cooling enclosure 3 as described by reference to FIG. 1, the drying, processing and cooling phases take place sequentially within said drying, processing and cooling enclosure 60 from which, when the cooling phase is complete, said not shown access door is opened, said at least one container 64 and said solid residues contained in it are removed from said drying, processing and cooling enclosure 60 and replaced by a further at least one container 64 loaded with moist material inserted into said drying, processing and cooling enclosure 60 through said not shown access door which is then closed in airtight manner, enabling the next drying phase to commence.

A vent 66 leads excess gases generated during the drying, cooling and processing phases respectively out of said drying, processing and cooling enclosure 60 towards a valve or damper 71, which directs said excess gases either via a duct 67 leading directly to atmosphere in not shown manner or into and through an optional condenser 68, or via a duct 69 leading into and through a combustor 70 leading to atmosphere, whereby, in use, atmospheric pressure is effectively maintained in said drying, processing and cooling enclosure 60 and, when no toxic or combustible emissions are present in said excess gases, said valve or damper 71 directs said excess gases vented from said drying, processing and cooling enclosure 60 via said duct 67 either directly to atmosphere or indirectly to atmosphere through said optional condenser 68, or, when toxic or combustible emissions are present in said excess gases, either via said duct 67 indirectly to atmosphere through said optional condenser 68 or via said duct 69 through said combustor 70.

Referring to FIG. 12, there is shown diagrammatically a plan view representation of a form of said alternative apparatus according to the invention comprising, by way of example when the combined duration of said drying and cooling phases is less than three times as long as the duration of the generation of excess process gases from said dried material during said processing phase, four drying, processing and cooling enclosures 60.1, 60.2, 60.3 and 60.4 with access doors 72.1, 72.2, 72.3 and 72.4 respectively able to be closed in airtight manner are provided, each of said four drying, processing and cooling enclosures 60.1, 6.02, 60.3 and 60.4 being as described by reference to FIG. 11, whereby, in use, by sequentially starting the drying phase in each of said four enclosures 60.1, 60.2, 60.3 and 60.4 respectively when less than two thirds of said combined duration of said drying and cooling phases has elapsed, the durations of the generation of excess process gases from said dried material during the processing phases taking place in at least two of said enclosures 60.1, 60.2, 60.3 and 60.4 overlap, thus ensuring that said excess process gases, when combustible, can be vented continuously into a preferably but not exclusively common combustor 70 in which said excess process gases can be continuously and cleanly combusted and from which the continuously produced combustion gases can be ducted through a duct 74, either through at least two not shown indirect heaters, one such indirect heater being located in each of said enclosures 60.1, 60.2, 60.3 and 60.4, to provide at least some of the thermal energy required by the drying and processing phases taking place sequentially in at least two of said enclosures 60.1, 60.2, 60.3 and 60.4 or, if not so required, either to provide at least some of the thermal energy required by an external process or to atmosphere, while, as described by reference to FIG. 11, if toxic emissions are not present in the excess gases generated and vented (as described below) during the drying and cooling phases, said excess gases may either be vented directly to atmosphere or into an optional common condenser 68, but if toxic missions are present in said excess gases then said excess gases are vented into said condenser 68 to enable said toxic emissions to be cooled and condensed and the condensate and any incondensible gases emerging from said condenser 68 ducted through a duct 73 and de-toxified, whereby, as an alternative to venting said excess gases containing toxic emissions into said condenser 68, said excess gases may be vented into said combustor 70 and said toxic emissions destroyed by combusting them therein.

Vents 66.1, 66.2, 66.3 and 66.4 respectively lead excess gases generated during the drying, processing and cooling phases respectively out of said drying, processing and cooling enclosures 60.1, 60.2, 60.3 and 60.4 respectively via ducts 67.1, 67.2, 67.3 and 67.4 respectively either in not shown manner directly to atmosphere or into said optional common condenser 68 from which the condensate and any incondensible gases emerging from said condenser 68 are ducted through a duct 73, or via ducts 69.1, 69.2, 69.3 and 69.4 respectively leading to a common combustor 70 from which the combustion gases are ducted through a duct 74, whereby, in use, valves or dampers 71.1, 71.2, 71.3 and 71.4 respectively direct excess gases vented from said drying, processing and cooling enclosures 60.1, 60.2, 60.3 and 60.4 during their respective drying and cooling phases via said ducts 67.1, 67.2, 67.3 and 67.4 respectively leading either in not shown manner to atmosphere or into said optional common condenser 68, or direct excess process gases vented during their respective processing phases from said drying, processing and cooling enclosures 60.1, 60.2, 60.3 and 60.4 via said ducts 69.1, 69.2, 69.3 and 69.4 respectively into said common combustor 70.

Referring again to FIG. 12, by way of example and on the basis that the sequenced starting of each new drying phase in said drying, processing and cooling enclosures 60.1, 60.2, 60.3 and 60.4 respectively is in reverse order to their numerical sequence, the first half of a drying phase is taking place in said enclosure 60.1 and the second half in said enclosure 60.2, their said valves or dampers 71.1 and 71.2 respectively being positioned to direct the excess gases being vented from them to atmosphere via the said ducts 67.1 and 67.2 respectively and said optional common condenser 68, a processing phase is taking place in said enclosure 60.3 and its said valve or damper 71.3 is positioned to direct the said excess process gases being vented from it to atmosphere via the said duct 69.3 and said common combustor 70, and a cooling phase is taking place in said enclosure 60.4 and its said valve or damper 71.4 is positioned to direct the excess gases being vented from it to atmosphere via the said duct 67.4 and said optional common condenser 68.

When the second half of the drying phase taking place in said enclosure 60.2 has been completed, its said valve or damper 71.2 is adjusted to close the entry to said duct 67.2 and open the entry to said duct 69.2 and the processing phase in said enclosure 60.2 and the venting of excess process gases from said enclosure 60.2 into said combustor 70 via said duct 69.2 commences, and when the processing phase taking place in said enclosure 60.3 and the cooling phase taking place in said enclosure 60.4 have both been completed, the injection of atomised water into said enclosure 60.4 ceases, its not shown recirculation fan is turned off and the injection of atomised water into said enclosure 60.3 commences to initiate said enclosure 60.3's cooling phase, while the first half of the drying phase taking place in enclosure 60.1 becomes the second half of the drying phase.

Said access door 72.4 is then be opened, said at least one container in said enclosure 60.4 with its load of cooled solid residues is removed and replaced by at least one container loaded with moist material and said access door 72.4 is closed, following which a new first half of a drying phase commences in said enclosure 60.4.

When following the above the second half of the drying phase taking place in said enclosure 60.1 has been completed, the above procedure is repeated analogously to maintain the continuous sequenced drying, processing and cooling of moist materials as described by reference to FIGS. 11 and 12.

Referring to FIG. 13, there is shown diagrammatically a side view sectional representation a further alternate apparatus for continuous processing of moist materials according to the invention comprising a loading enclosure 80, a drying enclosure 81, at least one processing enclosure 82, a cooling enclosure 83 and an unloading enclosure 84, said loading enclosure 80, drying enclosure 81, at least one processing enclosure 82, cooling enclosure 83 and unloading enclosure 84 being separable from each other by means of preferably sliding, and when closed airtight separation doors 85, 86, 87 and 88 and said loading enclosure 80 and said unloading enclosure 84 respectively being separable from the exterior of said further alternate apparatus by means of preferably sliding, and when closed airtight access doors 89 and 90 respectively. A container 91 holding moist material is shown awaiting loading, a container 92 holding moist material is shown in said loading enclosure 80, containers 93 and 94 holding material being dried are shown in said drying enclosure 81, containers 95 and 96 holding dried material being processed are shown in said at least one processing enclosure 82, containers 97 and 98 holding solid residues being cooled are shown in said cooling enclosure 83, a container 99 holding cooled solid residues is shown in said unloading enclosure 84 and container 100 holding cooled solid residues is shown subsequent to unloading.

Each said drying, processing and cooling enclosure 81, 82 and 83 has a separate, not shown recirculation path passing through it and the material in said containers 93 and 94, 95 and 96 and 97 and 98 respectively as described by reference to FIG. 11, except that said drying and processing enclosures 81 and 82's recirculation paths may include a not shown common indirect heater and only the separate recirculation path passing through said cooling enclosure 84 includes an atomised water injection nozzle, whereby, in use, containers loaded with moist material are conveyed sequentially by not shown conveying means first through said preferably slitting and when closed airtight access door 89 into said loading enclosure 80, then through said preferably sliding and when closed airtight separation door 85 into said drying enclosure 81 within which said moist material is dried, then through said preferably sliding and when closed airtight separation door 86 into said processing enclosure 82 within which said dried material is processed, then through said preferably sliding and when closed airtight separation door 87 into said cooling enclosure 83 within which said solid residues are cooled, then through said preferably sliding and when closed airtight separation door 88 into said unloading enclosure 84 and then through said preferably sliding and when closed airtight access door 90, whereby each said door opens before and closes in airtight manner after each said container passes through it and, when at least one container remains and the dried material in it continues to be processed in said processing enclosure, the venting into a combustor of the excess gases generated from said dried material being processed (as described by reference to FIGS. 11 and 12) enables the thermal energy generated by their combustion to provide at least some of the thermal energy required for the drying and processing of said moist materials.

In any embodiment of the present invention any reagent or reagents may be added to the superheated steam and/or hot process gases contained in or being recirculated through said drying and processing enclosures 10 and 11 respectively, and/or to the combustion gas, superheated steam or other inert gas contained in said cooling enclosure 12 first described by reference to FIG. 2, and/or to the gases recirculating in any of the drying, processing and cooling enclosures described by reference to FIGS. 11, 12 and 13, preferably but not exclusively by injection into the eye of any of the said recirculation fans 50, 51 and 53 described by reference to FIGS. 8, 9 and 10 respectively, or of any recirculation fan referred to by reference to FIGS. 11, 12 and 13, whereby, in use, the addition of any such reagent or reagents serves to enhance the value of said material while said material is being dried and processed or of said solid residues while said solid residues are being cooled, and/or which accelerates or otherwise improves the drying or processing of said material or the cooling of said solid residues.

By way of example, if the solid residues to be produced are charcoal, steam may be added to said hot process gases recirculating in any processing enclosure described by reference to FIGS. 1, 2, 9, 12, whereby, in use, the addition of said steam serves to accelerate the carbonisation of said dried organic material, and said charcoal may then be activated during the final stage of its processing phase by injecting and then recirculating superheated steam containing a portion of sulphuric acid through said charcoal at an elevated temperature, whereby, in use, said portion of sulphuric acid may be recovered for re-use by venting said superheated steam containing said portion of sulphuric acid into either the condenser or cooler 33.1 shown in FIG. 5 or in the condenser 68 shown in FIGS. 11 and 12 or into a separate, not shown condenser.

In any embodiment of the present invention the thermal energy transferred into any cooling medium employed to cool any or all of the gases recirculated through or vented into any of the condensing or cooling means herein described may be recovered for re-use, for example for space or any other heating purpose, whereby, in use, such re-use of thermal energy serves to enhance the viability of drying and processing said material and/or cooling said solid residues in any apparatus according to the invention herein described.

In any embodiment of the present invention at least a portion of said process gases or excess process gases vented from any of said processing enclosures or of said drying, processing and cooling enclosures may be employed as a fuel to generate electricity in a gas turbine or other internal combustion engine and the thermal energy then contained in the exhaust from any said gas turbine or other internal combustion engine may be employed to heat any of said drying or processing enclosures and/or any of said drying, processing and cooling enclosures, or for space or any other heating purpose, whereby, in use, such use of the combustion energy in said portion of said process gases or excess process gases serves to enhance the viability of drying and processing said material and/or cooling said solid residues in any apparatus according to the invention herein described.

In any embodiment of the present invention herein described, microwave or radio-frequency energy may be employed to pre-heat the moist material prior to or immediately following its entry into any said drying or drying, processing and cooling enclosure and/or to dry said moist material in any said drying or drying, processing and cooling enclosure, whereby, in use, the duration of the drying phase in any said enclosure is significantly reduced.

In those embodiments of the present invention described by reference to FIGS. 1 to 10 an inert gas other than steam having, at either slightly above 100° C. or at below 100° C., a density greater than that of ambient air, may be employed as the cooling medium being recirculated through said cooling enclosure 12 and may be cooled, and may cool said hot solid residues, to below 100° C., whereby, in use, said cooling enclosure 12 is located below the level 22.3 described by reference to FIG. 5 of the hot process gases/air stratification layer seal below said at least one processing enclosure 11 and, when at said either slightly above or said below 100° C. temperature the density of said inert gas other than steam is greater than that of ambient air, the hot solid residues inlet duct 19 is rearranged to lead downwardly into said cooling enclosure 12 and the cooled solid residues outlet duct 20 described by reference to FIG. 6 is rearranged to lead upwardly instead of downwardly from said cooling enclosure 12 and instead of the level 22.4 being that of a steam or other inert gas/air stratification layer seal it is that of an air/inert gas other than superheated steam stratification layer seal

By way of example, at 100° C. and atmospheric pressure argon has a density of 1.3048 gram/litre and air at an ambient temperature of 20° C. has a density of 1.2046 grams/litre, so if argon was the inert gas other than steam then its density at slightly above 100° C. and at below 100° C. would be greater than that of ambient air.

The methods and apparatus for processing moist material in superheated steam and other gases herein described may, when commercially advantageous, be combined, whereby, in use, moist material may, for example, be dried continuously in drying enclosure 10 in FIG. 2, then as dried material loaded into containers and processed and cooled as described by reference to FIGS. 11 and 12.

1. A method of processing organic material comprising locating the organic material within a processing enclosure, heating the organic material to a temperature exceeding 100° C. in an atmosphere comprising at least one of superheated steam, a hot inert gas, hot air and hot process gases, by recirculating the said at least one of superheated steam, a hot inert gas, hot air and hot process gases through a recirculation path, indirect heater means being provided to heat the gases passing along the recirculation path, valve means being provided to allow the replacement or substitution of gases and venting means being provided to allow the venting of gases, cooling means also being provided for the subsequent cooling of the heated organic material's solid residues in an atmosphere comprising at least one of superheated steam and an inert gas.

2. A method according to claim 1, further comprising an initial step of drying the organic material in an atmosphere comprising superheated steam, wherein a proportion of the superheated steam generated during the initial step of drying is vented.

3-23. (Cancelled)

24. A method according to claim 1, wherein a proportion of the atmosphere containing the hot process gases generated upon heating of the organic material is vented.

25. A method according to claim 24, wherein the solid residues remaining after the said proportion of the atmosphere containing the hot process gases generated upon heating of the organic material has been vented are cooled by recirculating an atmosphere comprising at least one of superheated steam and an inert gas through or around said solid residues.

26. A method according to claim 25, wherein, where the atmosphere in which the solid residues are cooled comprises superheated steam, the temperature of the superheated steam is controlled by supplying a controlled quantity of atomised water thereto, whereby a proportion of the superheated steam generated from the atomised water is vented.

27. A method according claim 24, wherein at least some of the hot process gases vented are combusted for immediate heating purposes.

28. A method according to claim 24, wherein at least some of the hot process gases vented are cooled and condensed for subsequent heating or other purposes.

29. A method according to claim 2, wherein at least some of the superheated steam vented is cooled and condensed for heating or other purposes.

30. A method according to claim 1, wherein the method is a batch method in which organic material is placed into an enclosure containing a controlled environment and, after any initial step of drying has taken place, is heated and subsequently cooled by supplying appropriate gases at appropriate temperatures to the environment.

31. A method according to claim 30, wherein at least one further enclosure containing a controlled environment is provided.

32. A method according to claims 1, in which organic material, after passing through any enclosure in which an initial step of drying takes place, is passed into a processing enclosure in which heating occurs, and said material's solid residues are subsequently passed into a cooling enclosure in which said residues are cooled.

33. A method according to claim 32, wherein the organic material or its solid residues enters and exits each enclosure through doors which, when closed, form seals substantially preventing the movement of gases into, between or from the enclosures.

34. A method according to claim 32, wherein the organic material or its solid residues enters and exits the enclosures through ducts which extend downwardly from the enclosures, temperature/density differential stratification layers forming in the ducts serving to form seals substantially preventing the movement of gases into, between or from the enclosures through the ducts.

35. A method according to claim 32, wherein at least one further processing enclosure is provided.

36. A processing apparatus for use in the batch processing of organic material comprising a processing and cooling enclosure, means for controlling the atmosphere within the processing and cooling enclosure to allow the recirculation of an atmosphere comprising at least one of superheated steam, a hot inert gas, hot air and hot process gases through or around indirect heater means and through or around organic material located within the processing and cooling enclosure to heat the organic material to a temperature in excess of 100° C., and to allow the recirculation of an atmosphere comprising at least one of superheated steam and an inert gas through or around cooling means and through or around the heated organic materials' solid residues within the processing and cooling enclosure to cool said solid residues, valve means to allow the replacement or substitution of gases, and venting means to allow the venting of gases.

37. An apparatus according to claim 36, further comprising means permitting an initial step of drying the organic material in said processing and cooling enclosure in an atmosphere comprising superheated steam to be performed, and venting means allowing a proportion of the superheated steam generated during the initial step of drying to be vented.

38. An apparatus according to claim 36, wherein at least one further processing and cooling enclosure is provided.

39. A processing apparatus for use in the processing of organic material comprising a processing enclosure, means for heating an atmosphere comprising at least one of superheated steam, a hot inert gas, hot air and hot process gases to a controlled temperature by recirculating said atmosphere through or around indirect heater means and through or around organic material located in a recirculation path within the processing enclosure to heat the organic material to a temperature in excess of 100° C., a cooling enclosure, means for cooling an atmosphere comprising at least one of superheated steam and an inert gas to a controlled temperature by recirculating said atmosphere through or around cooling means and through or around said organic material's solid residues within the cooling enclosure to cool said solid residues, conveying means for conveying organic material into and through the processing and cooling enclosures, valve means to allow the replacement or substitution of gases, venting means to allow the venting of gases, seal means substantially preventing the movement of gases into, between or from said enclosures, and processing enclosure vent means whereby at least a proportion of the atmosphere containing hot process gases produced upon heating of the organic material is vented.

40. An apparatus according to claim 39, further comprising a drying enclosure, means for recirculating an atmosphere comprising superheated steam through or around indirect heater means and through or around organic material located within the drying enclosure in order to dry said organic material, and venting means allowing a proportion of the superheated steam generated during drying to be vented.

41. An apparatus according to claim 39, further comprising at least one additional processing enclosure.

42. An apparatus according claim 39, wherein the seal means comprise mechanical seals or doors substantially preventing the flow of gases into, out of and between said enclosures.

43. An apparatus according to claim 39, wherein the seal means comprises ducts extending downwardly from the enclosures through which organic materials or their solid residues pass into and out of the enclosures, temperature/density differential stratification layers forming in the ducts, in use, to form seals substantially preventing the flow of gases into, out of and between said enclosures along said ducts.

44. An apparatus according to claim 39, wherein, where the atmosphere in which the solid residues are cooled comprises superheated steam, means are provided to control the temperature of the superheated steam by supplying a controlled quantity of atomised water thereto, and venting means are provided whereby a proportion of the superheated steam generated from the atomised water is vented.

45. An apparatus according to claim 39, wherein means are provided to enable at least some of the hot process gases vented during the heating of organic material to a temperature in excess of 100° C. to be combusted for immediate heating purposes.

46. An apparatus according to claim 39, wherein means are provided to enable at least some of the hot process gases vented during the heating of organic material to a temperature in excess of 100° C. to be cooled and condensed for subsequent heating or other purposes.

47. An apparatus according to claim 40, wherein means are provided to enable at least some of the superheated steam vented to be cooled and condensed for heating or other purposes.

48. A processing apparatus according to claim 39, further comprising means for use in the addition of at least one reagent to one or more of the recirculating atmospheres.
